(19) United States
(12) Patent Application Publication
(10) Pub. No.: US 2014/0211842 A1
(43) Pub. Date: Jul. 31, 2014

(54) Adapting Robustness in Video Coding

(71) Applicant: MICROSOFT CORPORATION, Redmond, WA (US)

(72) Inventors: David Zhao, Solna (SE); Sergey Nikiforov, Stockholm (SE); Konrad Hofbauer, Stockholm (SE); Magnus Hemmendorff, Stockholm (SE); Pontus Carlsson, Bromma (SE)

(73) Assignee: MICROSOFT CORPORATION, Redmond, WA (US)

(21) Appl. No.: 13/838,283

(22) Filed: Mar. 15, 2013

(30) Foreign Application Priority Data
Jan. 28, 2013 (GB) 1301445.1

(51) Int. Cl. H04N 7/26

(52) U.S. Cl. CPC H04N 19/00175
USPC 375/240.02

(57) ABSTRACT

An input receives a video signal comprising a plurality of frames, each comprising a plurality of image portions. Each of the image portions is encoded by an encoder, to generate an encoded signal. An adaptation module selects a respective encoding mode used to encode each of the image portions. The selection is based on a process that balances an estimate of distortion for the image portion if encoded using the respective encoding mode and a bitrate that would be incurred by encoding the image portion using the respective encoding mode. The adaptation module is also configured to determine, within each of one or more frames of the video signal, at least two different regions having different perceptual significance, and to adapt the above-mentioned process in dependence on which of the regions the image portion being encoded is in.

### RELATED APPLICATION

This application claims priority under 35 USC 119 or 365 to Great Britain Application No. 1301445.1 filed Jan. 28, 2013, the disclosure of which is incorporate in its entirety.

### BACKGROUND

In modern communications systems a video signal may be sent from one terminal to another over a medium such as a wired and/or wireless network, often a packet-based network such as the Internet. Typically the frames of the video are encoded by an encoder at the transmitting terminal in order to compress them for transmission over the network. The encoding for a given frame may comprise intra frame encoding whereby blocks are encoded relative to other blocks in the same frame. In this case a target block is encoded in terms of a difference (the residual) between that block and a neighbouring block. Alternatively the encoding for some frames may comprise inter frame encoding whereby blocks in the target frame are encoded relative to corresponding portions in a preceding frame, typically based on motion prediction. In this case a target block is encoded in terms of a motion vector identifying an offset between the block and the corresponding portion from which it is to be predicted, and a difference (the residual) between the block and the corresponding portion from which it is predicted. A corresponding decoder at the receiver decodes the frames of the received video signal based on the appropriate type of prediction, in order to decompress them for output to a screen.

However, frames or parts of frames may be lost in transmission. For instance, typically packet-based networks do not guarantee delivery of all packets, e.g. one or more of the packets may be dropped at an intermediate router due to congestion. As another example, data may be corrupted due to poor conditions of the network medium, e.g. noise or interference. Forward error correction (FEC) or other such error protection techniques can sometimes be used to recover lost packets, based on redundant information included in the encoded bitstream. However, no error protection technique is perfect and certain packets may still not be recovered after attempted correction. Alternatively a system designer may not want to incur the overhead of redundant information used for error protection, at least not in all circumstances. Hence loss may still occur.

Robustness refers to the ability of a coding scheme to be insensitive to loss, in terms of how distortion is affected in presence of loss. An inter frame requires fewer bits to encode than an intra frame, but it is less robust as it introduces a dependency on a previous frame. Even if the inter frame is received, it cannot be decoded properly if something in its history has been lost (a frame or part of a frame comprising a reference from which it was predicted, or frame or part of a frame from which that reference was predicted, etc.). Hence distortion due to loss can propagate over a number of frames. Intra frame encoding is more robust as it only relies on receipt of a reference in the current frame, so the decoding state can be recovered even if there has been previous loss. The downside is that intra coding incurs more bits in the encoded bitstream. Another possible trick to improve robustness is to have the decoder feed back a confirmation of frames or parts of frames that are successfully received and decoded, and to use a confirmed reference mode which restricts the encoder to encoding a current block only relative to confirmed references. However, this restricts the candidates for prediction to references further back in time, which tend to be less similar and so achieve less gain in terms of prediction (i.e. result in a larger residual).

Considering the various possible coding modes such as intra frame encoding, inter frame encoding and encoding relative to confirmed references, there is therefore a trade-off to be made between robustness (in terms of guarding against potential distortion) and the bitrate incurred in the encoded signal. Loss adaptive rate-distortion optimisation (LARDO) is a technique which may be applied at the encoder side to try to optimise this trade-off. For each macroblock under consideration, LARDO measures an estimate of distortion D that would be experienced by encoding the macroblock in each of a plurality of available encoding modes, and the bitrate that would be incurred in the encoded bitstream using each of those encoding modes. The estimate of distortion D may take into account both source coding distortion (e.g. due quantisation) and an estimate of potential distortion due to loss (based on a probability of loss occurring over the channel in question). The LARDO process at the encoder then selects the encoding mode which minimises a function of the form D+λR where λ is a parameter characterising the trade-off.

### SUMMARY

According to one aspect, the disclosure herein relates to an apparatus having an input for receiving a video signal comprising a plurality of frames, each comprising a plurality of image portions; and an encoder for encoding each of the image portions to generate an encoded signal. For example the image portions in question may be the blocks or macroblocks of any suitable codec, or any other desired division of a frame. The encoder is capable of encoding each of the portions (e.g. each block or macroblock) using any selected one of two or more different encoding modes, having different rate-distortion trade-offs. For example the encoding modes may comprise an intra frame encoding mode, an inter frame encoding mode and/or a mode which the target portion to being encoded relative to a confirmed references (confirmed as received by the receiving terminal).

To control this, the apparatus comprises an adaptation module arranged to select the encoding mode used to encode each of the image portions respectively. The adaptation uses a rate-distortion optimisation process whereby it balances a function of distortion and bitrate. The function is a function of encoding mode, and comprises at least a part representing an estimate of the potential distortion that would be experienced at the decoder if the target portion is encoded with a certain encoding mode, and a part representing a bitrate that would be incurred in the encoded signal by encoding the image portion using that encoding mode. Thus the adaptation module is able to consider the potential rate-distortion trade-off for encoding the target portion according to each of a plurality of different encoding modes, and it selects the mode that is estimated to provide the optimal trade-off according to some optimisation criterion.

Further, the adaptation module is also configured to determine, within a frame, at least two different regions having different perceptual significance. For example this may comprise determining at least a region of interest, e.g. a face in a video call, having a greater significance than a background region outside the region of interest. In embodiments, the adaptation module may determine a perceptual sensitivity map having various different regions (more than two at least), and determine a level of perceptual significance for each region. The level may be determined from amongst various different possible levels (again more than two at least). The above-mentioned function is then adapted in dependence on which of the regions the image portion being encoded is in, e.g. adapting a weighting applied to one of the parts of the function in dependence in the perceptual significance of the respective region.

In embodiments, the part of the function representing distortion comprises at least an estimate of potential distortion due to loss, e.g. taking into account the possibility of the target image portion being lost or something in its history being lost. In embodiments the estimate of distortion may take into account both source coding distortion and the possibility of loss. Thus in embodiments a higher robustness (lower sensitivity to loss) may be applied in a region of interest or region of higher perceptual significance, at the expense of more bits in the encoded signal; while a lower robustness (higher sensitivity to loss) may be applied in one or more other regions, with the saving of fewer bits being used to encode those regions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### BRIEF DESCRIPTION OF THE DRAWINGS

FIG. 1 is a schematic representation of a video stream,

FIG. 2 is a schematic block diagram of a communication system,

FIG. 3 is a schematic representation of an encoded video stream,

FIG. 4 is a schematic block diagram of an encoder,

FIG. 5 is a schematic block diagram of a decoder, and

FIG. 6 is a schematic representation of a video image to be encoded and an example of a corresponding perceptual importance map.

### DETAILED DESCRIPTION

Robustness tools such as LARDO can be expensive in terms of rate-distortion performance, if the optimisation function is strongly weighted towards avoiding distortion at the expense of high bitrate. On the other hand if saving on bitrate is weighted too heavily, robustness tools like LARDO can produce a significant quality drop which may be unwarranted in case of good network conditions.

The following embodiments adapt robustness to subjective importance within a frame. LARDO-type tools (encoding relative to confirmed references, intra blocks, etc.) can be applied with spatial selectivity. For example, a region of interest (ROI) within a frame may be determined at the encoder side, and a greater robustness may be given to blocks or macroblocks being encoded within the region of interest than those outside (e.g. in a LARDO optimization, a greater weighting against distortion is given to macroblocks in the ROI at the expense of higher bitrate, whereas outside the ROI fewer bits are spent). Extending this idea, LARDO-type tools can be applied with spatial selectivity in a continuous manner (e.g. proportional to spatial distortion sensitivity). For example a perceptual sensitivity map may be determined in which different regions may be given different levels of interest from amongst the various levels of a scale (of more than two levels), e.g. mapping different levels to each block or macroblock within a frame. Robustness may then be adapted in dependence on the level associated with each region (e.g. the weighting in a LARDO optimisation function may be adapted in dependence on level of perceptual significance, giving a greater weighting against distortion to those macroblocks with a higher level of significance than those with a lower level).

Use of these tools may also be combined with ROI-aware concealment quality estimation, to determine whether frames may be discarded when concealment quality is estimated to be low

Embodiments may thus produce higher frame rate during loss, with acceptable quality in one or more regions of interest, at a smaller bitrate overhead than is currently possible.

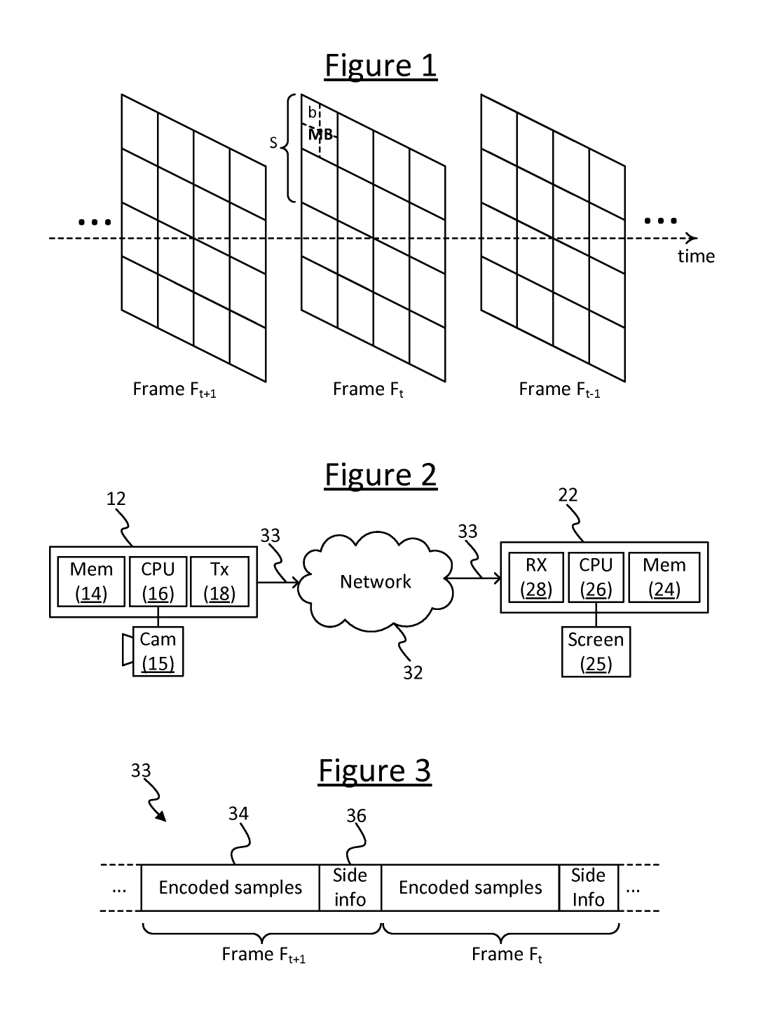

FIG. 1 gives a schematic illustration of an input video signal captured from a camera, and divided into portions ready to be encoded by a video encoder so as to generate an encoded bitstream. The signal comprises a moving video image divided in time into plurality of frames (F), each frame representing the image at a different respective moment in time ( . . . t−1, t, t+1 . . . ). Within each frame, the frame is divided in space into a plurality of portions each representing a plurality of pixels. The portions may for example be referred to as blocks. In certain schemes, the frame is divided and sub-divided into different levels of portion or block. For example each frame may be divided into macroblocks (MB) and each macroblock may be divided into blocks (b), e.g. each block representing a region of 8×8 pixels within a frame and each macroblock representing a region of 2×2 blocks (16×16 pixels). In certain schemes each frame can also be divided into slices (S), each comprising a plurality of macroblocks.

A block in the input signal may initially be represented in the spatial domain, where each channel is represented as a function of spatial position within the block, e.g. each of the luminance (Y) and chrominance (U,V) channels being a function of Cartesian coordinates x and y, Y(x,y), U(x,y) and V(x,y). In this representation, each block or portion is represented by a set of pixel values at different spatial coordinates, e.g. x and y coordinates, so that each channel of the colour space is represented in terms of a particular value at a particular location within the block, another value at another location within the block, and so forth.

The block may however be transformed into a transform domain representation as part of the encoding process, typically a spatial frequency domain representation (sometimes just referred to as the frequency domain). In the frequency domain the block is represented in terms of a system of frequency components representing the variation in each colour space channel across the block, e.g. the variation in each of the luminance Y and the two chrominances U and V across the block. Mathematically speaking, in the frequency domain each of the channels (each of the luminance and two chrominance channels or such like) is represented as a function of spatial frequency, having the dimension of 1/length in a given direction. For example this could be denoted by wavenumbers kₓ and k_{y} in the horizontal and vertical directions respectively, so that the channels may be expressed as Y(kₓ, k_{y}), U(kₓ, k_{y}) and V(kₓ, k_{y}) respectively. The block is therefore transformed to a set of coefficients which may be considered to represent the amplitudes of different spatial frequency terms which make up the block. Possibilities for such transforms include the Discrete Cosine transform (DCT), Karhunen-Loeve Transform (KLT), or others.

An example communication system in which the various embodiments may be employed is illustrated schematically in the block diagram of FIG. 2. The communication system comprises a first, transmitting terminal 12 and a second, receiving terminal 22. For example, each terminal 12, 22 may comprise one of a mobile phone or smart phone, tablet, laptop computer, desktop computer, or other household appliance such as a television set, set-top box, stereo system, etc. The first and second terminals 12, 22 are each operatively coupled to a communication network 32 and the first, transmitting terminal 12 is thereby arranged to transmit signals which will be received by the second, receiving terminal 22. Of course the transmitting terminal 12 may also be capable of receiving signals from the receiving terminal 22 and vice versa, but for the purpose of discussion the transmission is described herein from the perspective of the first terminal 12 and the reception is described from the perspective of the second terminal 22. The communication network 32 may comprise for example a packet-based network such as a wide area internet and/or local area network, and/or a mobile cellular network.

The first terminal 12 comprises a computer-readable storage medium 14 such as a flash memory or other electronic memory, a magnetic storage device, and/or an optical storage device. The first terminal 12 also comprises a processing apparatus 16 in the form of a processor or CPU having one or more execution units; a transceiver such as a wired or wireless modem having at least a transmitter 18; and a video camera 15 which may or may not be housed within the same casing as the rest of the terminal 12. The storage medium 14, video camera 15 and transmitter 18 are each operatively coupled to the processing apparatus 16, and the transmitter 18 is operatively coupled to the network 32 via a wired or wireless link. Similarly, the second terminal 22 comprises a computer-readable storage medium 24 such as an electronic, magnetic, and/or an optical storage device; and a processing apparatus 26 in the form of a CPU having one or more execution units. The second terminal comprises a transceiver such as a wired or wireless modem having at least a receiver 28; and a screen 25 which may or may not be housed within the same casing as the rest of the terminal 22. The storage medium 24, screen 25 and receiver 28 of the second terminal are each operatively coupled to the respective processing apparatus 26, and the receiver 28 is operatively coupled to the network 32 via a wired or wireless link.

The storage 14 on the first terminal 12 stores at least a video encoder arranged to be executed on the processing apparatus 16. When executed the encoder receives a “raw” (unencoded) input video stream from the video camera 15, encodes the video stream so as to compress it into a lower bitrate stream, and outputs the encoded video stream for transmission via the transmitter 18 and communication network 32 to the receiver 28 of the second terminal 22. The storage 24 on the second terminal 22 stores at least a video decoder arranged to be executed on its own processing apparatus 26. When executed the decoder receives the encoded video stream from the receiver 28 and decodes it for output to the screen 25. A generic term that may be used to refer to an encoder and/or decoder is a codec.

FIG. 3 gives a schematic representation of an encoded bitstream 33 as would be transmitted from the encoder running on the transmitting terminal 12 to the decoder running on the receiving terminal 22. The bitstream 33 comprises a plurality of encoded samples 34 for each frame, including any motion vectors. In one application, the bitstream may be transmitted as part of a live (real-time) video phone call such as a VoIP (Voice-over-Internet Protocol) call between the transmitting and receiving terminals 12, 22 (VoIP calls can also include video).

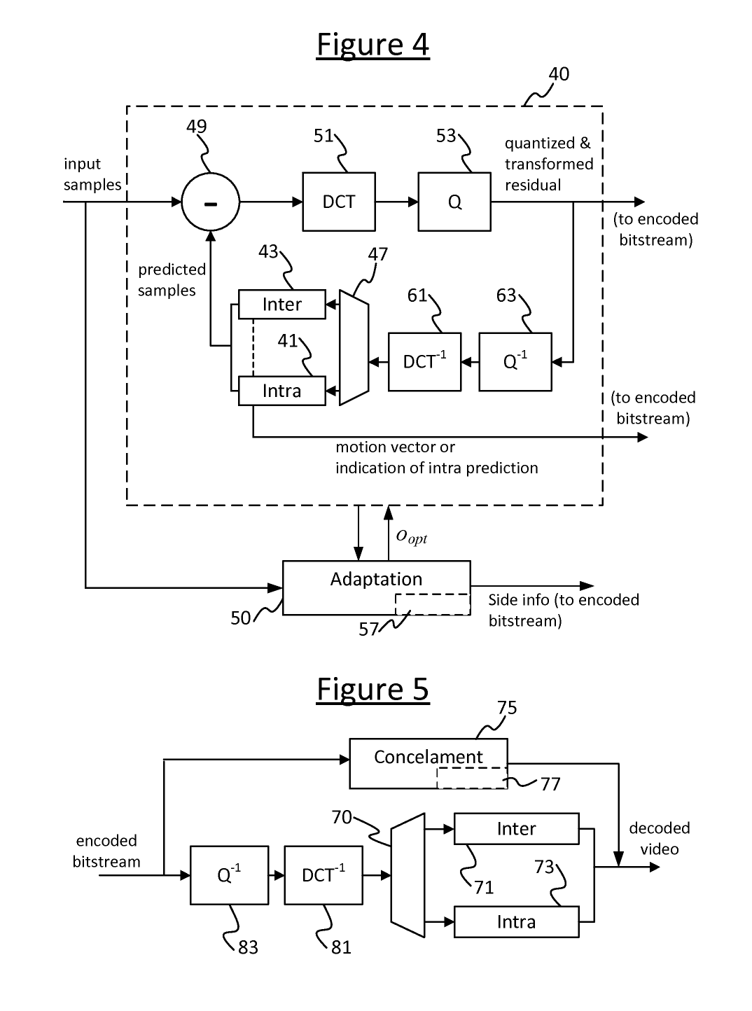

FIG. 4 is a high-level block diagram schematically illustrating an encoder such as might be implemented on transmitting terminal 12. The encoder comprises: a discrete cosine transform (DCT) module 51, a quantizer 53, an inverse transform module 61, an inverse quantizer 63, an intra prediction module 41, an inter prediction module 43, a switch 47, and a subtraction stage (−) 49. The encoder also comprises an adaptation module 50, including a spatial selectivity sub-module 57. Each of these modules or stages may be implemented as a portion of code stored on the transmitting terminal's storage medium 14 and arranged for execution on its processing apparatus 16, though the possibility of some or all of these being wholly or partially implemented in dedicated hardware circuitry is not excluded.

The subtraction stage 49 is arranged to receive an instance of the input video signal comprising a plurality of blocks (b) over a plurality of frames (F). The input video stream is received from a camera 15 coupled to the input of the subtraction stage 49. The intra or inter prediction 41, 43 generates a predicted version of a current (target) block to be encoded based on a prediction from another, already-encoded block or other such portion. The predicted version is supplied to an input of the subtraction stage 49, where it is subtracted from the input signal (i.e. the actual signal) to produce a residual signal representing a difference between the predicted version of the block and the corresponding block in the actual input signal.

In intra prediction mode, the intra prediction 41 module generates a predicted version of the current (target) block to be encoded based on a prediction from another, already-encoded block in the same frame, typically a neighbouring block. When performing intra frame encoding, the idea is to only encode and transmit a measure of how a portion of image data within a frame differs from another portion within that same frame. That portion can then be predicted at the decoder (given some absolute data to begin with), and so it is only necessary to transmit the difference between the prediction and the actual data rather than the actual data itself. The difference signal is typically smaller in magnitude, so takes fewer bits to encode.

In inter prediction mode, the inter prediction module 43 generates a predicted version of the current (target) block to be encoded based on a prediction from another, already-encoded region in a different frame than the current block, offset by a motion vector predicted by the inter prediction module 43 (inter prediction may also be referred to as motion prediction). In this case, the inter prediction module 43 is switched into the feedback path by switch 47, in place of the intra frame prediction stage 41, and so a feedback loop is thus created between blocks of one frame and another in order to encode the inter frame relative to those of a preceding frame. This typically takes even fewer bits to encode than intra frame encoding.

The samples of the residual signal (comprising the residual blocks after the predictions are subtracted from the input signal) are output from the subtraction stage 49 through the transform (DCT) module 51 (or other suitable transformation) where their residual values are converted into the frequency domain, then to the quantizer 53 where the transformed values are converted to discrete quantization indices. The quantized, transformed indices of the residual as generated by the transform and quantization modules 51, 53, as well as an indication of the prediction used in the prediction modules 41,43 and any motion vectors generated by the inter prediction module 43, are all output for inclusion in the encoded video stream 33 (see element 34 in FIG. 3); typically via a further, lossless encoding stage such as an entropy encoder (not shown) where the prediction values and transformed, quantized indices may be further compressed using lossless encoding techniques known in the art.

An instance of the quantized, transformed signal is also fed back though the inverse quantizer 63 and inverse transform module 61 to generate a predicted version of the block (as would be seen at the decoder) for use by the selected prediction module 41 or 43 in predicting a subsequent block to be encoded. Similarly, the current target block being encoded is predicted based on an inverse quantized and inverse transformed version of a previously encoded block. The switch 47 is arranged pass the output of the inverse quantizer 63 to the input of either the intra prediction module 41 or inter prediction module 43 as appropriate to the encoding used for the frame or block currently being encoded.

According to the above, in embodiments the encoder thus has at least two possible encoding modes: intra prediction and inter prediction.

Alternatively or additionally, at least the inter prediction coding module 43 may be configured with a confirmed reference mode and a non confirmed reference mode. In the confirmed reference mode, the inter prediction module 43 is arranged to receive back acknowledgement messages from the decoder (Shown in FIG. 5) to acknowledge when frames or parts of frames have been successfully received and decoded (and/or equivalently to report when not). The inter prediction module 43 thus has confirmation of which frames or parts of frames will serve as a proper reference for inter prediction at the decoder. In the confirmed reference mode, encoding is restricted to prediction from reference portions in a frame or part of a frame that is confirmed as received and decoded. In the non confirmed reference mode on the other hand, the inter prediction module 43 does not restrict to encoding relative to such confirmed references. For example, in embodiments the feedback requires a few frames to be returned, so for recent frames it is not known whether these frames are successfully received or not, and these can be used for potential references. Or in embodiments, the feedback is positive only if the full frame is reconstructed correctly at the receiver, so even in a frame which is known not to be confirmed there is a chance that a portion of that frame contains a good reference.

Encoding relative to confirmed references is more robust, so on the whole results in less distortion due to loss. However, non-confirmed reference frames is are closer in time (e.g. previous frame) and therefore provide better prediction and overall rate-distortion performance apart from the issue of potential loss. The temporal distance to the most recent confirmed reference frames depends on the network roundtrip time (as the sender is getting a confirmation from the receiver that a particular frame was decoded correctly). For instance, if the roundtrip time is 200 ms and the frame /rate is 30 fps, this means that the most recent confirmed reference frame is 6 frames back. Constantly using frame t−6 instead of t−1 as reference frame would tend to provide significantly worse rate-distortion performance due to smaller prediction gain. That is, the older references tend to be less similar and so result in a larger residual.

Further possible encoding modes may include different modes based on different levels of partitioning of macroblocks, e.g. selecting between a higher complexity mode in which a separate prediction is performed for each 4×4 block within a macroblock or a lower complexity mode in which prediction is performed based on only 8×8 or 8×16 blocks or even whole macroblocks. The available modes may also include different options for performing prediction. For example, in one intra mode the pixels of a 4×4 block (b) may be determined by extrapolating down from the neighbouring pixels from the block immediately above, or by extrapolating sideways from the block immediately to the left. Another prediction mode called “skip mode” may also be provided in some codecs, which may be considered as an alternative type of inter mode. In skip mode the target's motion vector is inferred based on the motion vectors to the top and to the left and there is no encoding of residual coefficients. The manner in which the motion vector is inferred is consistent with motion vector prediction, and thus the motion vector difference is zero so it is only required to signal that the MB is a skip block.

The possibility of having different coding options can be used to increase the rate-distortion efficiency of a video codec. In this case an optimal coding representation (according to some optimisation criterion) is to be found for every frame region.

The adaptation module 50 at the encoder is configured to apply a loss adaptive rate-distortion optimisation (LARDO) process to select an optimal encoding mode for encoding each macroblock according to an optimisation criterion, for example as follows. The adaptation module 50 is coupled to the rest of the encoder so as to have visibility of the encoding and decoding state of any appropriate ones of the elements in FIG. 4 according to the encoding mode being considered, so it can see the original (unencoded) samples, the residual, and the reconstructed versions of the samples following decoding. In a loss adaptive set-up, the adaptation module 50 also has an instance of the concealment module 75 substantially similar to that at the decoder (see FIG. 5, discussed shortly), so it can see the effect of potential loss and concealment of that loss as might be seen at the decoder.

In embodiments, the rate-distortion performance optimisation problem can be formulated in terms of minimising distortion under a bit rate constraint R. For example a Lagrangian optimisation framework can be used to solve the problem, in which the optimisation criterion may be formulated as:

J=D(m, o)+λR(m, o), (1)

where J represents the Lagrange function, D represents a measure of distortion (a function of mode o and macroblock m or macroblock sub-partition), R is the bitrate, and λ is a parameter defining a trade-off between distortion and rate.

Solving the Lagrangian optimisation problem means finding the encoding mode o which minimises the Lagrange function J, where the Lagrange function J comprises at least a term representing distortion, a term representing bitrate, and a factor (the “Lagrange multiplier”) representing a trade-off between the two. As the encoding mode o is varied towards more robust and/or better quality encoding modes then the distortion term D will decrease. However, at the same time the rate term R will increase, and at a certain point dependent on λ the increase in R will outweigh the decrease in D. Hence the expression J will have some minimum value, and the encoding mode o at which this occurs is considered the optimal encoding mode.

In this sense the bitrate R, or rather the term λR, places a constraint on the optimization in that this term pulls the optimal encoding mode back from ever increasing quality. The mode at which this optimal balance is found will depend on A, and hence λ may be considered to represent a trade-off between bitrate and distortion.

The Lagrangian optimisation may be used in the process of choosing coding decisions, and is applied for every frame portion (e.g. every macroblock of 16×16 pixels).

The distortion D may be quantified as a difference measure, such as a sum of squared differences (SSD) between original and reconstructed pixels, or a sum of absolute differences (SAD), a mean square error (MSE) or a peak signal to noise ratio (PSNR). In embodiments it may be evaluated to account for all processing stages including: prediction, transform (from a spatial domain representation of the pixels of each block or macroblock to a transform domain representation such as an optical frequency domain representation), and quantization (the process of converting a digital approximation of a continuous signal to more discrete, lower granularity quantization levels). Furthermore, in order to compute reconstructed pixels, steps of inverse quantization, inverse transform, and inverse prediction may be performed. Alternatively some of these encoding and decoding stages may be left out of the estimation in order to reduce complexity. Further, the rate term R may also account for coding of some or all parameters, including parameters describing prediction and quantized transform coefficients. Parameters are typically coded with an entropy coder (not shown), and in that case the rate can be an estimate of the rate that would be obtained by the entropy coder, or can be obtained by actually running the entropy coder and measuring the resulting rate for each of the candidate modes. Entropy coding/decoding is a lossless process and as such doesn't affect the distortion.

LARDO takes into account an estimate of end-to-end distortion based on an assumption of an erroneous transmission channel. By tracking the potential distortion, the adaptation module 50 is able to compute a bias term related to the expected error-propagation distortion (at the decoder) that is added to the source coding distortion when computing the cost for macroblocks being encoded with the different encoding modes (e.g. inter and intra) within the encoder rate-distortion loop. Thus the potential distortion as would be seen by the decoder is estimated, due to source coding and channel errors. The estimated potential distortion is then indirectly used to bias the mode selection towards intra coding (if there is a probability of channel errors).

An example of such an “end-to-end” distortion expression may be based on a distortion measure such as SSD and may assume a Bernoulli distribution for losing macroblocks. In this case the optimal macroblock mode oₒₚₜ may be given by:

$${o}_{opt} = {arg min}_{o} ( {D}_{s} ( m , o ) + {D}_{ep - ref} ( m , o ) + λ R ( m , o ) ) , \qquad ( 2 )$$

where Dₛ(m,o) denotes the distortion (e.g. SSD) between the original and reconstructed pixel block for macroblock m and macroblock mode o, R the total rate, and λ the Lagrange multiplier relating the distortion and the rate term. D_{ep-ref}(m,o) denotes the expected distortion within the reference block in the decoder due to error propagation. D_{ep-ref}(m,o) thus provides a bias term which biases the optimisation toward intra coding (or some other robust mode) if error propagation distortion becomes too large. D_{ep-ref}(m,o) is zero for the intra coded macroblock modes. The expression Dₛ(m,o)+D_{ep-ref}(m,o)+λR(m, o) may be considered an instance of a Lagrange function J. Argminₒ outputs the value of the argument o for which the value of the expression J is minimum.

With LARDO there is a statistical model for the “expected distortion” in non-confirmed references. For example, if some region of the video is static, this region is likely to have small distortion after concealment. Therefore, this region in a non-confirmed reference frame provides smaller expected distortion (in a statistical sense) from the prediction, compared to referring to a very complex and/or moving region of a non-confirmed reference frame. Basically it is a function of the expected packet loss and distortion introduced by concealment.

For example, the total expected error propagation distortion map Dₑₚ is driven by the performance of the error concealment and may be updated after each macroblock mode selection as:

Dₑₚ(m(k), n+1)=(1-p)D_{ep-ref}(m(k), n, oₒₚₜ)+p(D_{ec-rec}(m(k), n, oₒₚₜ)+D_{ec-ep}(m(k), n)), (³)

where n is the frame number, m(k) denotes the k^{th} sub-partition (block) of macroblock m, p the probability of packet loss (which may be a predetermined parameter, or determined using information fed back from the decoder based on observation of actual channel conditions). In one example the error-propagation distortion may be stored on a 4×4 pixel block granularity. The error-propagation reference distortion D_{ep-ref}(m,o) for a bock or macroblock is estimated by averaging the distortions in the error-propagation distortion map of the previous frame corresponding to the block position indicated by the motion vectors of the current block. _{Dec-rec} denotes the difference (e.g. SSD) between the reconstructed and error concealed pixels in the encoder, and D_{ec-ep} the expected difference (e.g. SSD) between the error concealed pixels in the encoder and decoder. Typically, a lost block is reconstructed by copying a block from a previous frame (e.g., using frame copy or motion copy error concealment method). In this case, D_{ec-ep} is obtained by extracting the corresponding distortion from the error propagation distortion map of the frame used for error concealment.

Thus the loss adaptive bias term may be based on a term representing an estimate of the distortion that would be experienced, if the target portion (e.g. block or macroblock) does arrive over the channel, due to non arrival of a reference portion in the target portion's history from which prediction of the target portion depends; and on a concealment term representing an estimate of distortion that would be experienced due to concealment if the target portion is lost. The concealment term may comprise a term representing a measure of concealment distortion of the target portion (e.g. block or macroblock) relative to an image portion that would be used to conceal loss of the target portion if the target portion is lost over the channel, and a term representing an estimate of distortion that would be experienced due to loss of an image portion in the target portion's history upon which concealment of the target portion depends.

Turning to the spatial selectivity sub-module 57 provided at the encoder side, in accordance with embodiments disclosed herein this is configured to apply a spatial selectivity to the LARDO process or other such rate-distortion trade-off performed by the adaptation module 50.

In embodiments the spatial selectivity sub-module 57 may be configured to identify a region of interest (ROI) in the video being encoded for transmission. For example, this may be done by applying a facial recognition algorithm, examples of which in themselves are known in the art. The facial recognition algorithm recognises a face in the video image to be encoded, and based on this identifies the region of the image comprising the face or at least some of the face (e.g. facial features like mouth, eyes and eyebrows) as the region of interest. The facial recognition algorithm may be configured specifically to recognise a human face, or may recognise faces of one or more other creatures. In other embodiments a region of interest may be identified on another basis than facial recognition. Other alternatives include other types of image recognition algorithm such as a motion recognition algorithm to identify a moving object as the region of interest, or a user-defined region of interest specified by a user of the transmitting terminal 12.

In further embodiments, the spatial selectivity sub-module 57 may be configured not just to identify a single levelled region of interest, but to determine a perceptual sensitivity map whereby several different regions are allocated several different levels of perceptual significance. For instance this may be done on a macroblock-by-macroblock basis, whereby each macroblock is mapped to a respective level of perceptual significance selected from a scale. The map may be determined by a facial recognition algorithm, e.g. configured to assign a highest level of perceptual significance to main facial features (e.g. eyes, eyebrows, mouth); a next highest level to peripheral facial features (e.g. cheeks, nose, ears); a next lowest level to remaining areas of the head and shoulders or other bodily features, and a lowest level to background areas (e.g. stationary scenery). Other alternatives include other types of image recognition algorithm such as a motion recognition algorithm to allocate levels of perceptual significance in dependence on an amount of motion or change, or user-defined maps specified by a user of the transmitting terminal 12 (e.g. the user specifies a centre of interest and the levels decrease spatially outwards in a pattern from that centre).

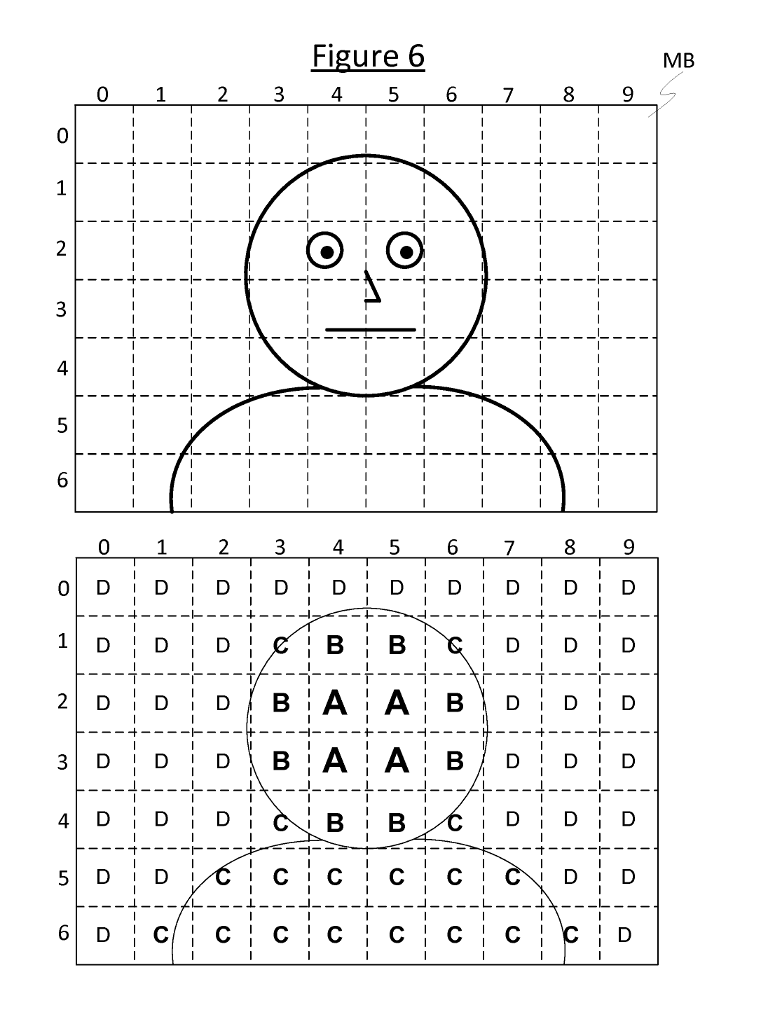

An example is illustrated schematically in FIG. 6. The figure shows one frame of a “talking head” type video image, e.g. as would typically occur in a video call. The top illustration in FIG. 6 shows the frame divided into portions such as blocks or macroblocks (MB). Note that the size of the macroblocks is exaggerated for illustrative purposes (relative to those of a typical video codec, though in general any size blocks or macroblocks can be used). The bottom illustration in FIG. 6 shows a map of the same frame with different macroblocks given different perceptual significance. For example, certain macroblocks such as those at (x,y) ccordinates (4,2) (4,3) (5,2) and (5,3) may be identified as forming the region of interest, e.g. macroblocks that include at least some of the face, or a selection of blocks which cover main features of the face. Or further, as an example of a perceptual sensitivity map, the macroblocks labelled A in FIG. 6 may be assigned a first (highest) level of perceptual significance, the macroblocks labelled B may be assigned a second (next highest) level of perceptual significance, the macroblocks labelled C may be assigned a third (next lowest) level of perceptual significance, and the macroblocks labelled D may be assigned a fourth (lowest) level of perceptual significance.

Based on this region of interest or perceptual sensitivity map, the spatial selectivitysub-module 57 is configured to adapt the LARDO process (or other such rate-distortion optimisation process) to give a greater robustness to one or more regions of higher perceptual importance, while spending fewer bits on one or more regions of lower perceptual importance. In embodiments this may be done by adapting the parameter λ in an expression of the form:

D+λR,

to be optimised as a function of encoding mode o, e.g. equations (1) or (2) above. That is, different values of λ may be mapped to the different levels of perceptual significance/sensitivity.

For example in the case of a single-level region of interest, one value may be allocated to the region of interest and another to the background:

If MB(k) is in ROI, λ=λ_{ROI}

Else λ=λ_{bg}

In another example, different values of λ are mapped to different levels of perceptual significance, e.g.:

If MB(k) has level A, λ=λ_{A}

If MB(k) has level B, λ=λ_{B}

If MB(k) has level C, λ=λ_{C}

Else λ=λ_{D}

In the above expression of the form D+λR, a higher value of λ gives more weight to minimising the rate term, so λ will be lower for regions of greater perceptual significance (i.e. it is not desired to be too sparing on bitrate for those regions). An equivalent form would be (1/λ)D+R or βD+R, where β is greater for regions of higher significance (more weight is given to minimising distortion in those regions) . Other expressions may be employed which comprise a part representing distortion and a part representing number of bits incurred, and some way of varying the relative weighting (significance) between the two.

In embodiments, the spatial selectivity sub-module 57 may be configured to output an indication of the region of interest or perceptual importance map, which is transmitted to the decoder at the receiving terminal 22, e.g. in side info 36 embedded in the encoded bitstream 33, or in a separate stream or signal. See again FIG. 3. This is not needed by the decoder to decode the video, as the encoding mode for each macroblock will be encoded into the encoded bitstream with the encoded samples 34 anyway. However, in certain embodiments it may be included to aid the decoder in determining whether to apply concealment, as will be discussed in more detail shortly.

FIG. 5 is a high-level block diagram schematically illustrating a decoder such as might be implemented on receiving terminal 22. The decoder comprises an inverse quantization stage 83, an inverse DCT transform stage 81, a switch 70, and an intra prediction stage 71 and a motion compensation stage 73. The decoder also comprises a concealment module 75, which in some embodiments may comprise a spatial selectivity sub-module 77. Each of these modules or stages may be implemented as a portion of code stored on the receiving terminal's storage medium 24 and arranged for execution on its processing apparatus 26, though the possibility of some or all of these being wholly or partially implemented in dedicated hardware circuitry is not excluded.

The inverse quantizer 81 is arranged to receive the encoded signal 33 from the encoder, via the receiver 28. The inverse quantizer 81 converts the quantization indices in the encoded signal into de-quantized samples of the residual signal (comprising the residual blocks) and passes the de-quantized samples to the reverse DCT module 81 where they are transformed back from the frequency domain to the spatial domain.

The switch 70 then passes the de-quantized, spatial domain residual samples to the intra or inter prediction module 71 or 73 as appropriate to the prediction mode used for the current frame or block being decoded, and the intra or inter prediction module 71, 73 uses intra or inter prediction respectively to decode the blocks of each macroblock. Which mode to use is determined using the indication of the prediction and/or any motion vectors received with the encoded samples 34 in the encoded bitstream 33. If a plurality of different types of intra or inter coding modes are present in the bitstream and if these require different decoding, e.g. different modes based on different partitioning of macroblocks, or a skip mode, then this is also indicated to the relevant one of the intra or inter decoding module 71, 73 along with the samples 34 in the encoded bistream 33, and the relevant module 71, 73 will decode the macroblocks according to each respective mode.

The output of the DCT module 51 (or other suitable transformation) is a transformed residual signal comprising a plurality of transformed blocks for each frame. The decoded blocks are output to the screen 25 at the receiving terminal 22.

Further, the concealment module 75 is coupled to so as to have visibility of the incoming bitstream 33 from the receiver 28. In event that a frame or part of a frame is lost (e.g. due to packet loss or corruption of data), the concealment module 75 detects this and selects whether to apply a concealment algorithm. If the concealment algorithm is applied, this works either by projecting a replacement for lost patches of a frame (or even a whole lost frame) from a preceding, received frame; or projects a replacement for a lost patches of a frame from one or more other, received parts of the same frame. That is, either by extrapolating a replacement for a lost frame or lost part of a frame from a preceding, received frame; or extrapolating a replacement for a lost part of a frame from another, received part of the same frame; or estimating a replacement for a lost part of a frame by interpolating between received parts of the same frame. Details of concealment algorithms in themselves are known in the art.

In embodiments, the spatial selectivity sub-module 77 is configured to adapt the decision as to whether to apply concealment. To do this, it identifies a region of interest in the incoming video image. In embodiments, this may be achieved using the region of interest or perceptual sensitivity map signalled in the side info 36 received from the transmitting terminal 12, e.g. extracting it from the incoming bitstream 33. In the case of a perceptual sensitivity map having several different levels of significance, the region of interest may be determined at the decoder side by taking those macroblocks having greater than a certain level as the region of interest, e.g. those labelled A and B in the example of FIG. 6 (while those labelled D or C are considered background). Alternatively the region of interest may be signalled explicitly. In other alternative embodiments, and any of the techniques described above for identifying a region of interest may be applied independently at the decoder side at the receiving terminal 22. For example the facial recognition algorithm or other image recognition algorithm may be applied in the spatial selectivity sub-module 77 of the decoder at the receiving terminal 22, or a user-defined region of interest may be specified by a user of the receiving terminal 22. In the case of an image recognition algorithm such as a facial recognition algorithm applied at the decoder side, in event of loss this may be based on a previously received, successfully decoded frame, on the assumption that in most cases the region of interest is unlikely to have moved significantly from one frame to the next.

By whatever means the region of interest is identified at the decoder side, the sub-module 77 is configured to determine an estimate of concealment quality that is selectively directed toward the region of interest within the frame. That is, the estimate is directed to a particular region smaller than the frame—either in that the estimate is only based on the region of interest, or in that the estimate is at least biased towards that region. Based on such an estimate, the concealment module determines whether or not to apply the concealment algorithm. If the quality estimate is good enough, concealment is applied. Otherwise the receiving terminal just freezes the last successfully received and decoded frame.

In a communication scenario, the face is often of greatest importance, relative to the background or other objects. In determining whether to display a concealed frame or not, if the concealment quality estimation just estimates the quality of the full frame without taking content into account, then this can result in a concealed frame being displayed even though the face area contains major artefacts. Conversely, a potential concealed frame may be discarded even though the face has good quality while only the background contains artefacts. Hence there is a potential problem in that concealed frames which could be beneficial to display are sometimes not displayed, while concealed frames that are not beneficial to display sometimes do end up being displayed.

In embodiments, the region of interest is used to inform a yes/no decision about concealment that applies for the whole frame. The quality estimation is targeted in a prejudicial fashion on the region of interest to decide whether to apply concealment or not, but once that decision has been made it is applied for the whole frame, potentially including other regions such as the background. That is, while concealment may always be applied locally, to repair lost patches, in embodiments it is determined how much can be patched locally before the entire frame should be discarded. I.e. while only those individual patches where data is lost are concealed, the decision about concealment is applied once per frame on a frame-by-frame basis. In one such embodiment, the concealed version of the image is displayed if the face regions are good enough. If the face region is degraded too much using concealment, it may be better to instead discard the entire frame.

The concealment quality provides an estimate of the quality of a concealed version of the lost portion(s) if concealed using the concealment algorithm.

In some embodiments the sub-module 77 could determine the concealment quality using an estimate received from the transmitting terminal 12 (based on running simulated loss scenarios at the encoder side), e.g. being signalled in the side info 36 encoded bitstream 33. In other embodiments, an encoder side concealment quality estimation is not needed, and instead the concealment quality estimation is performed by the sub-module 77 in the concealment module 75 at the decoder side. In this case, as there is no knowledge of the actual lost data at the decoder, the concealment quality instead has to be estimated “blindly” based on successfully received parts of the target frame and/or one or more previously received frames.

In embodiments, the decoder-side sub-module 77 may look at parts of the present frame adjacent to the lost patch(es) in order to estimate concealment quality. For example this technique can be used to enable the sub-module 77 to predict the PSNR of the concealed frame at the decoder side (or other difference measure such as SSD, SAD or MSE). The estimation of quality may be based on an analysis of the difference between received pixels adjacent to a concealed block (that is, pixels surrounding the concealed block in the current, target frame frame) and the corresponding adjacent pixels of the concealed block's reference block (that is, pixels surrounding the reference block in a reference frame of the video signal).

In another example, the concealment quality estimation may be based on a difference between two or more preceding, successfully received and decoded frames. For example, the MSE or PSNR may instead be calculated, in the region of interest, between two preceding, successfully received and decoded frames or parts of those frames. The difference between those two preceding frames may be taken as an estimate of the degree of change expected from the preceding frame to the current, target frame (that which is lost), on the assumption that the current frame would have probably continued to change by a similar degree if received. E.g. if there was a large average difference in the region of interest between the last two received frames (e.g. measured in terms of MSE or PSNR), it is likely that the current, target frame would have continued to exhibit this degree of difference and concealment will be poor. But if there was only a small average difference in the region of interest between the last two received frames, it is likely that the current, target frame would have continued not to be very different and concealment will be relatively good quality. As another alternative, it is possible to look at the motion vectors of a preceding frame. For example, if an average magnitude of the motion vectors in the region of interest are large, a lot of change is expected and concealment will likely be poor quality; but if the average magnitude of motion vector is small, not much change is expected and concealment will likely provide reasonably good quality. E.g. if the motion vectors indicate a motion that is greater than a threshold then error concealment may be considered ineffective.

By whatever technique the concealment quality is estimated, the estimate of concealment quality is focused on the region of interest—either in that the difference measure (whether applied at encoder or decode side) is only based on samples, blocks or macroblocks in the region or interest, to the exclusion of those outside; or in that terms in the difference sum or average are weighted with a greater significance for samples, blocks or macroblocks in the region of interest, relative to those outside the region of interest. For example the selectivity could be implemented using a weighted scoring, i.e. by importance mask, or centre of importance.

The spatial selectivity sub-module 77 in the concealment module 75 is thus configured to make the selection as to whether or not to apply the concealment algorithm based on the concealment quality estimate for the region of interest. In embodiments, the concealment, module 75 is configured to apply a threshold to the concealment quality estimate. If the concealment quality estimate is good relative to a threshold (meets and/or is better than the threshold), the concealment module 75 selects to apply the concealment algorithm. If the concealment quality estimate is bad relative to a threshold (is worse than and/or not better than the threshold), the concealment module 75 selects not to apply the concealment algorithm. Instead it may freeze the preceding frame.

In embodiments, the selection is applied for the whole frame, even though the concealment quality estimate was only based on the smaller region of interest within that frame (or at least biased towards the region of interest within that frame). That is to say, the estimate of concealment quality for the region of interest is used to decide whether or not to produce a concealed version the whole frame, including both the region of interest and the remaining region of that frame outside the region of interest—the concealment algorithm concealing patches both inside and outside the region of interest. So in the example of FIG. 6, the concealment quality estimate may be made only based on (or biased towards) the blocks covering the main facial region, but may be used to make a concealment decision that is considered relevant for the whole frame including any blocks lost from amongst the foreground blocks and any blocks lost from amongst the background blocks. For example, it often does not matter to a user if the background contains concealment artefects, so it may not be worthwhile selecting individually how to treat those blocks.

It will be appreciated that the above embodiments have been described only by way of example.

For instance, note that “optimal” or “optimisation”, or the like, does not necessarily mean best in an absolute sense, but rather the result of a function representing an attempt to balance between rate and distortion. Where the line lies between the two depends on the application in question, and is a matter for design choice. The disclosure herein does not prescribe where to draw the line, but rather provides tools allowing the designer to adapt that line in dependence on perceptual significance in the video image being encoded.

Further, optimising a function is not limited to solving a mathematical function in an analytical sense. There are other ways of achieving the same effect (or at least good enough), such as by implementing the optimisation function in terms of a set of pre-determined solutions in one or more look-up-tables, and/or an algorithm or set of rules. In some embodiments such an implementation may execute faster, and may be more convenient to tune (e.g. look-up-table or rules may be based on a posteriori sources such as experiments on humans). Thus the optimisation function may be implemented in the form of any process that balances an estimate of distortion against bitrate for candidate encoding modes.

Further, the scope of this disclosure is not limited to the above coding modes. The skilled person will be aware of various different encoding modes that may be used to provide a different trade-off between rate and distortion, and any such modes may be used in conjunction with the teachings set out herein.

Further, while the above has been described in terms of blocks and macroblocks, the region of interest does not have to be mapped or defined in terms of the blocks or macroblocks of any particular standard. In embodiments the region of interest may be mapped or defined in terms of any portion or portions of the frame, even down to a pixel-by-pixel level, and the portions used to define the region of interest do not have to be same as the divisions used for other encoding/decoding operations such as prediction (though in embodiments they may well be).

Further, loss is not limited to packet dropping, but could also refer for example to any loss due to corruption. In this case some data may be received but not in a usable form, i.e. not all the intended data is received, meaning that information is lost. Further, the various embodiments are not limited to an application in which the encoded video is transmitted over a network. For example in another application, receiving may also refer to receiving the video from a storage device such as an optical disk, hard drive or other magnetic storage, or “flash” memory stick or other electronic memory. In this case the video may be transferred by storing the video on the storage medium at the transmitting device, removing the storage medium and physically transporting it to be connected to the receiving device where it is retrieved. Alternatively the receiving device may have previously stored the video itself at local storage. Even when the terminal is to receive the encoded video from storage medium such as a hard drive, optical disc, memory stick or the like, stored data may still become corrupted over time, resulting in loss of information.

Further, the decoder does not necessarily have to be implemented at an end user terminal, nor output the video for immediate consumption at the receiving terminal. In alternative implementations, the receiving terminal may be a server running the decoder software, for outputting video to another terminal in decoded and/or concealed form, or storing the decoded video for later consumption. Similarly the encoder does not have to be implemented at an end-user terminal, nor encode video originating from the transmitting terminal. In other embodiments the transmitting terminal may for example be

Regarding concealment, note that in embodiments a region of interest does not have to be identified or used at the decoder side. It is not essential that the decoder knows about the region of interest or perceptual sensitivity map used by the encoder, as the encoding mode for each macroblock (or other such portion) will in any case be indicated in the encoded video signal. In some embodiments a region of interest may be used for a different purpose at the decoder, to guide a concealment decision as discussed above, but this addition need not be included in all embodiments. In other embodiments, concealment may be applied at the decoder side just based on whether there is loss, or based on a concealment quality estimate made indiscriminately over the whole frame.

Further, the disclosure is not limited to the use of any particular concealment algorithm and various suitable concealment algorithms in themselves will be known to a person skilled in the art. The terms “project”, “extrapolate” or “interpolate” used above are not intended to limit to any specific mathematical operation. Generally the concealment may use any operation for attempting to regenerate a replacement for lost data by projecting from other, received image data that is nearby in space and/or time (as opposed to just freezing past data).

The techniques disclosed herein can be implemented as an intrinsic part of an encoder or decoder, e.g. incorporated as an update to an existing standard such as H.264 or H.265, or can be implemented as an add-on to an existing standard such as an add-on to H.264 or H.265. Further, the scope of the disclosure is not restricted specifically to any particular representation of video samples whether in terms of RGB, YUV or otherwise. Nor is the scope limited to any particular quantization, nor to a DCT transform. E.g. an alternative transform such as a Karhunen-LoeveTransform (KLT) could be used, or no transform may be used. Further, the disclosure is not limited to VoIP communications or communications over any particular kind of network, but could be used in any network capable of communicating digital data, or in a system for storing encoded data on a storage medium.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. Apparatus comprising:
an input for receiving a video signal comprising a plurality of frames, each comprising a plurality of image portions;
an encoder for encoding each of the image portions, to generate an encoded signal; and
an adaptation module arranged to select a respective encoding mode used to encode each of the image portions, based on a process that balances an estimate of distortion for the image portion if encoded using the respective encoding mode against a bitrate that would be incurred by encoding the image portion using the respective encoding mode;
wherein the adaptation module is configured to determine, within each of one or more frames of the video signal, at least two different regions having different perceptual significance, and to adapt said process in dependence on which of the regions the image portion being encoded is in.

2. The apparatus of claim 1, wherein the adaptation module is configured to perform said determination for each of the one or more frames by determining a perceptual sensitivity map comprising more than two different regions and determining for each a respective level of perceptual significance, and to perform said adaptation by adapting said process in dependence on the level of perceptual significance assigned to the region of the perceptual importance map that the image portion being encoded is in.

3. The apparatus of claim 2, wherein the adaptation module is configured to determine each respective level of perceptual significance from amongst more than two different levels, so that the different regions between them have more than two levels of perceptual significance.

4. The apparatus of claim 2, wherein the adaptation module is configured to determine the perceptual importance map by determining a level of perceptual significance for each of the image portions individually.

5. The apparatus of claim 1, wherein the adaptation module is configured to perform said determination for each of the one or more frames by determining a region of interest in the frames of the video signal, and to adapt said process in dependence on whether or not the image portion being encoded is in the region of interest.

6. The apparatus of claim 1, wherein the adaptation module is configured to perform said determination based on a facial recognition algorithm.

7. The apparatus of claim 1, wherein the adaptation module is configured to select the encoding mode used to encode one or more of the image portions from amongst a group of available encoding modes comprising an intra frame encoding mode and an inter frame encoding mode.

8. The apparatus of claim 1, wherein the adaptation module is configured to select the encoding mode used to encode one or more of the image portions from amongst a group of available encoding modes comprising a mode which encodes relative to a reference portion that has been confirmed as received by a receiving terminal, and a mode not that does not restrict to encoding relative to a reference portion that has been confirmed as received.

9. The apparatus of claim 1, wherein the estimate of distortion comprises at least an estimate of potential distortion that would be experienced due to loss.

10. The apparatus of claim 9, wherein the estimate of distortion comprises both a measure of distortion due to source coding and the estimate of potential distortion due to loss.

11. The apparatus of claim 9, wherein the estimate of potential distortion due to loss comprises an estimate of distortion due to concealment.

12. The apparatus of claim 9, wherein the estimate of potential distortion due to loss comprises an estimate of the potential distortion that would be experienced at a receiving terminal if the image portion is lost, and the potential distortion that would be experienced at a receiving terminal if the image portion being encoded is received but a reference portion upon which its encoding depends is lost.

13. The apparatus of claim 1, wherein said process comprises a weighting applied to one of the distortion estimate and the bitrate, and the adaptation module is configured to perform said adaptation by adapting the weighting.

14. The apparatus of claim 1, comprising a transmitter arranged to transmit the encoded signal over a lossy network to a receiving terminal.

15. The apparatus of claim 14, wherein the network over which the transmitter is arranged to transmit comprises a packet-based network.

16. The apparatus of claim 14, wherein the transmitter is arranged to transmit the encoded signal as part of a live video call.

17. The apparatus of claim 14, wherein the transmitter is arranged to transmit to the receiving terminal information indicative of said regions and their perceptual significance, at least relative to one another, for the receiving terminal to use in determining whether to apply concealment.

18. A system comprising the apparatus of claim any preceding claim, and further comprising a receiving terminal which comprises:
a receiver for receiving the encoded signal;
a decoder for decoding the encoded signal to generate a decoded signal for output to a screen, storage device or further terminal; and
a concealment module for applying a concealment algorithm in a frame of the decoded signal having lost data;
wherein the concealment module is configured to determine at least two different regions having different perceptual significance within each of one or more frames of the video signal, to determine an estimate of concealment quality selectively directed toward at least one region having a higher perceptual significance relative to at least one other region, and based on said estimate of concealment quality to determine whether or not to apply the concealment algorithm.

19. A computer program product for encoding a video signal comprising a plurality of frames, comprising code embodied on a computer-readable storage medium and configured so as when executed on a processing apparatus to perform operations comprising:
receiving a video signal comprising a plurality of frames, each comprising a plurality of image portions;
encoding each of the image portions, to generate an encoded signal;
in performing said encoding, selecting a respective encoding mode used to encode each of the image portions, based on a process that balances an estimate of distortion for the image portion if encoded using the respective encoding mode against a bitrate that would be incurred by encoding the image portion using the respective encoding mode; and
to perform said selecting, determining at least two different regions having different perceptual significance within each of one or more frames of the video signal, and adapting said process in dependence on which of the regions the image portion being encoded is in.

20. A computer program product comprising code embodied on a computer-readable storage medium and configured so as when executed on a transmitting terminal to perform operations comprising:
receiving a video signal comprising a plurality of frames, each comprising a plurality of image portions;
encoding each of the image portions, to generate an encoded signal;
in performing said encoding, selecting an encoding mode used to encode each of the image portions respectively, by selecting an encoding mode that optimises a function of encoding mode, the function comprising (i) a part representing an estimate of distortion for the image portion, comprising a measure of source coding distortion and an estimate of potential distortion that would be experienced due to loss, (ii) a part representing a bitrate that would be incurred by encoding the image portion, and (iii) a weighting applied to one of said parts;
to perform said selecting, determining a perceptual importance map comprising more than two different regions and assigning to each a respective level of perceptual significance from amongst more than two different levels, and adapting the weighting of said function in dependence on the level of perceptual significance assigned to the region of the perceptual importance map that the image portion being encoded is in; and
transmitting the encoded signal to a receiving terminal over a lossy, packet-based network as part of a live packet-based video call.
